(19) United States
(12) Patent Application Publication
(10) Pub. No.: US 2007/0208100 A1
(43) Pub. Date: Sep. 6, 2007

(54) CURABLE COMPOSITIONS FOR PROVIDING A CURED COMPOSITION WITH ENHANCED WATER RESISTANCE

(76) Inventors: Anbu Natesh, North Wales, PA (US); Levi Scott, Upper Darby, PA (US); Shailesh Shah, Dresher, PA (US)

Correspondence Address: COGNIS CORPORATION;PATENT DEPARTMENT, 300 BROOKSIDE AVENUE, AMBLER, PA, 19002, US

(21) Appl. No.: 11/680,097

(22) Filed: Feb. 28, 2007

Related U.S. Application Data
(60) Provisional application No. 60/778,053, filed on Mar. 1, 2006.

(51) Int. Cl. C08F 290/06

(52) U.S. Cl. 522/81

(57) ABSTRACT

The invention is an energy-curable composition which contains a dual functional component which has at least one ethylenically unsaturated group and at least one carboxylic acid-functional group and a nanoparticle metal oxide component. The curable composition can optionally contain initiators (photoinitiators and/or free radical initiators), components which can react with the dual functional component and additives generally present in energy-curable compositions.

### RELATED APPLICATIONS

This application claims priority from Provisional Application Ser. No. 60/778,053 filed Mar. 1, 2006, the entire contents of which are incorporated herein by reference.

### FIELD OF THE INVENTION

The invention is directed to an energy-curable particularly to radiation-curable compositions useful as adhesives, coatings, ink formulations, composite materials and the like. The composition of the present invention provides a polymer with improved bond strength, adhesion and moisture-resistance.

### BRIEF DESCRIPTION OF THE INVENTION

The present invention is an energy-curable composition comprising a compound, oligomer or low-molecular weight polymer having a polymerizable ethylenically unsaturated group and a carboxylic acid-functional group (dual-functional component). Preferably, the ethylenically unsaturated polymerizable group comprises a vinyl ether group, (meth)acrylic group, allyl group, or α-olefin group, which is preferably at the terminal portion of the moiety or on a pendent group to a polymer chain. The curable ethylenically unsaturated component also contains a carboxyl group which is preferably at a terminal position in the compound, oligomer or low molecular weight polymer, or can be included in a pendant side chain to a polymeric material. Preferably the carboxyl group is not neutralized or esterified. Preferably the polymerizable dual-functional component (polymerizable ethylenical unsaturation and a carboxyl group) has a molecular weight in a range of from about 150 to about 10,000, preferably from about 200 to about 5,000, and most preferably from about 250 to about 3,000 number average molecular weight.

The composition can, in addition, contain low-molecular weight components and/or oligomer materials which are mixable with the dual-functional ethylenically unsaturated component and contains groups which are polymerizable with the dual-functional component.

An additional critical component of the present invention comprises nano particle-size metal oxides, preferably zinc oxide. The nano particle size metal oxide improves the bond strength and moisture resistance of the cured polymeric material.

### DETAILED DESCRIPTION OF THE INVENTION

The dual-functional (ethylenically unsaturated and carboxyl functional) components are well known in the art and have been used in energy-curable formulations for many years. Dual-functional energy curable compositions are disclosed in U.S. Pat. No. 5,912,381, U.S. Pat. No. 6,429,235, U.S. Pat. No. 6,908,665, U.S. Pat. No. 6,472,056, and U.S. Pat. No. 6,565,696, the entire contents of each patent is incorporated herein by reference. The patents incorporated herein by reference disclose various types of dual-functional components which can be useful in the practice of the invention, formulations containing the components, methods of curing the composition, additional components and additives, and methods for preparing the useful components.

The important characteristics of the dual-functional polymerizable components useful in the practice of the present invention is that they contain at least one polymerizable ethylenically unsaturated group and at least one carboxyl functional group. The dual-functional components can be compounds with relatively low molecular weights in the range of 150 Daltons or less or oligomeric materials with a molecular weight (Mn) in a range up to about 10,000, preferably up to about 5,000, and most preferably up to about 2,000.

The dual-functional component(s) can be present in a range of from about 1% to about 99% and, preferably from about 10% to about 90%, and most preferably from about 25% to about 75% by weight of the energy-curable composition.

The energy-curable composition of the present invention can optionally contain components and oligomers which have functional groups with polymerizable ethylenical unsaturation, with reactable hydrogen atoms or groups reactable with the reactable hydrogen atoms in groups such as hydroxyl, carboxyl, amide, isocyanate, vinyl ether, epoxy, and the like.

Suitable dual-functional components include materials such as 1,2 cyclohexanedicarboxylic anhydride modified with hydroxy ethyl acrylate, caprolactone-modified hydroxy ethyl acrylate, phthalic anhydride modified with hydroxy ethyl acrylate, alkyl or alkenyl succinic anhydride modified with hydroxy ethyl acrylate, dimer acid modified with ditrimethylolpropanetriacrylate, maleic anhydride modified with a hydroxy ethyl acrylate, dimer acid modified with trimethylolpropane diacrylate, and the homologous allyl compounds. The acids and anhydrides are modified by reaction of only a portion of the carboxyl groups with the ethylenically unsaturated compositions. Generally only one of the two carboxyl groups which form the anhydride are reacted or only one of the dimer acid groups is modified. The listing is only illustrative and a broader scope of useful components is shown in the patents included herein by reference.

Optional components useful in the composition of the present invention include aliphatic urethane acrylates in a molecular weight (Mn) range of about 1,000 to about 3,000, isobornyl acrylate, propoxylated trimethylol propane triacrylate, propoxylated nonylphenolacrylate, and the like. The list is illustrative only and is not exhaustive of the compounds which can be included in the composition of the invention. The optional components can be present in an amount of from about 5% to about 75%, preferably from about 10% to about 60%, and most preferably from about 15% to about 50% by weight of the energy curable composition

The metal oxide useful in the practice of the present invention comprises nanoscale size particles of metal oxide. Nanoscale particles have a mean particle size of less than 1 micron. The nanoscale particles preferably have a mean particle size of less than about 800 nm, more preferably less than about 500 nm, and most preferably in the range of up to about 400 nm. Metal oxides include materials such as aluminum oxide, titanium dioxide, zinc oxide, and the like. The metal oxide nanoscale particles can be present in a range of from about 0.01% to about 15% by weight of the energy curable composition, and preferably in a range of 0.1% to about 10% by weight of the curable composition, and most preferably in a range of from 0.5% to 5% by weight of the composition.

When zinc oxide is used as the metal oxide, depending upon the particle size of the nanoscale zinc oxide, the composition of the present invention, when cured, can be a clear material since zinc oxide in a certain nano particle size range can transmit visible light. However, certain nano particles of zinc oxide do not transmit visible light and would provide a cloudy or opaque nature to the cured composition.

Nano particle-size zinc oxide in a transparent form is available as TECYLOXYL™ UV from Elementis. If transparency is not a problem, such as when the curable composition of the present invention is utilized as an adhesive for opaque materials, other grades of nano particle-size zinc oxide can be utilized.

As is well known in the art, nano particles of certain metal oxides in certain particle-size ranges filter out or absorb certain frequencies of ultraviolet radiation. This can make curing the composition of the present invention with UV radiation difficult unless the wave length of the radiation is selected to be in a range in which the radiation utilized to cure the composition is not absorbed or reflected by the metal oxide nano particles. However, since the absorption or reflection of the UV radiation is not generally total, the composition of the present invention can be cured by increasing the intensity of the UV radiation applied to cure the composition. Nano particle size zinc oxide is a preferred metal oxide.

The composition of the present invention can be cured by electron beam (EB) radiation without the difficulties involved in absorption or reflection of the radiation by the nanoscale zinc particles in the composition. EB curing can also be applied to objects which are opaque to UV radiation. Generally, the EB curing can be done at a relatively low temperature so that distortion of the articles by heat does not occur.

A least preferred method of curing the composition of the present invention is by use of polymerized initiators which aid in polymerizing the composition at elevated temperatures. The curing can be done at the elevated temperatures by use of free radical initiator or if the temperature is sufficiently high, can be carried out without use of free radical initiators. The free radical initiators can be selected to cure the composition at selected temperature ranges.

The energy-curable composition of the present invention can contain materials which are co-polymerizable with the dual-functional energy-curable components useful in the practice of the present invention. The additional materials can be added to the composition to control properties of the polymerized composition. That is, polymerizable materials to control properties such as flexibility, hardness, temperature-resistance, solvent-resistance, moisture-resistance and the like can be included in the energy-polymerizable composition of the present invention. The additional materials contain groups which are reactive with at least one of the groups in the dual-functional materials. Since the dual-functional components comprise at least one polymerizable double bond and at lease one carboxyl functional group, materials which contain groups which are reactive with the polymerizable unsaturated groups and/or the free-carboxyl groups can be included in the energy-curable composition. The structure of the additional polymerizable materials are selected to improve at least one property of the cured composition. Properties such as flexibility, hardness, solvent-resistance, impact-resistance, and adhesion can be affected by the additional co-polymerizable materials.

Additional materials can include materials such as modified polyamides, modified epoxy acrylates Mn in the range of about 1,000 to about 10,000, isobornyl acrylate, propoxylated trimethylol propane triacrylate, decanedioldiacrylate, aliphatic polyester resin with 60% hexane dioldiacrylate, propoxylated nonylphenolacrylate and the like. The additional materials can contain reactive groups such as the polymerizable ethylenically unsaturated groups, hydroxyl groups, amine groups, and the like. The additional materials should contain groups which are polymerizable with the dual-functional components of the composition or with themselves or other additives to the composition. Preferably the additional materials are copolymerizable with the dual-functional components through the ethylenically unsaturated group.

The polymerizable composition can contain materials such as plasticizers to modify the flexibility, brittleness, hardness, and the like of the cured composition. The plasticizers should be carefully selected so that they do not adversely affect properties such as adhesion to the particular substrate to which the composition is applied. Additional materials usually present in energy-curable compositions such as polymerization inhibitors, stabilizers, rheology modifiers, diluents, oxidation inhibitors, anti-aging components, pigments, and the like can be present in the composition of the invention.

The properties of the cured polymeric composition can also be modified by the functionality of the additional components added to the composition. The functionality of the additional components affects the amount of crosslinking of the composition and can provide cured polymers with a higher hardness and/or less brittleness, improved temperature resistance, improved flexibility, improved solvent resistance, and the like.

The combination of the dual-functional polymerizable components with the nanoscale metal oxide increases the adhesion and moisture-resistance of the cured polymer.

The composition of the present invention can be cured by heat combined with the use of a catalyst (free radical initiator), by UV light and by EB. The most preferred method for curing the composition is by EB which can be utilized to cure the composition when it is associated with thin films which may be opaque and an assured thorough cure is required. The composition of the invention can be cured to a degree in which the cured polymer contains very low concentrations of migrants which permits use of the composition in association with food products. The composition is particularly useful in laminating and sealing polymer packaging for food products.

The composition of the invention can be applied as a surface coating on substrates, particularly paper-like substrates, and cured to improve the water-resistance of the substrate. The composition of the invention can be applied to a paper-like substrate, allowed to remain in contact for a time period to permit the composition of the invention to penetrate the thin substrate to which it is applied and curing the composition preferably by UV or EB radiation.

The composition of the present invention can also be included in printing ink formulations which contain various pigments and other components to provide the properties required in the printing ink formulation. The composition of the present invention improves the adhesion of the ink to the substrate and, in addition, increases the water and moisture resistance of the printed materials. The increase in the water resistance of the substrate and the printing ink on application and curing of the composition is useful where moisture resistance or water resistance improvement is required.

In the preferred embodiment of the invention wherein the composition is cured by EB radiation, photoinitiators are not required in the composition. However, when the composition is to be cured by UV radiation, a photoinitiator is generally required. Photoinitiators for UV curing compositions are well known in the art and are generally useful as an initiating agent in the composition of the invention. If migrants are a problem, such as in association with food products, the photoinitiators can be of the high molecular weight type or a type which is incorporated into the polymer during the curing process. The use of high molecular weight photoinitiators and polymerizable photoinitiators can be useful in preventing migration of the photoinitiators to the surface of the cured composition. This is particularly useful when the cured product is to be used in association with a food product. That is, when used for the laminating adhesives or a sealant for films for food packaging.

The composition of the present invention provides good adhesion to different substrates such as poly-α-olefins, metals, polyamides, polyesters, polyethers, polyurethanes and the like.

The composition of the present invention was prepared and tested according to the following procedure. A 10-12 micron layer of each formulation to be tested was coated on a six inch by 8 inch metalized foil substrate. A polyester film (DuPont Teijin Films 48 LBT, size 12), was placed adjacent to the adhesive-coated surface of the metalized foil substrate and passed through a card laminator. The resultant laminated film was then cured at 100 ft/min @ 30 kilograys using an electron beam radiation source. One inch strips were cut from the cured laminate and peel strength values were taken at 12 in/min on a Thwing-Albert Friction/Peel Tester, Model 225-1, immediately after curing. The EB cured sample strips were allowed to equilibrate for two days at room temperature. After two days the sample strips were immersed in water at 60° C. for one hour and the sample strips were peel tested immediately after removal from the water. The composition of the adhesive and the results of the peel test are shown in Table 1:

TABLE 1

| | Composition Percent by Weight | | | | |
|---|---|---|---|---|---|
| Component | 1 | 2 | 3 | 4 | 5 |
| CDAHA *** | 74 | 70 | 74 | 70 | 75 |
| ECX 6026 * | 25 | 25 | 25 | 25 | 25 |
| Nanoparticle ZnO ** | 1 | 5 | | | |
| Zinc Ricinoleate | | | 1 | 5 | |
| Peel Strength after | 450 | 450 | 12.82 | 18.46 | <10 |
| immersion in water at | (Film Tore) | (Film Tore) | | | |
| 60° C. for one hour. | | | | | |
| grams/inch | | | | | |

* ECX 6026 Aliphatic urethane acrylate (2,000 Mₙ)
** Nanoparticle ZnO mean particle size 50-70 nm
*** CDAHA 1,2 Cyclohexane dicarboxylic anhydride modified with hydroxyethyl acrylate

As can be seen from the results of the tests shown in Table 1, the addition of nanoparticle ZnO has a substantial affect on the peel strength of an adhesive bonded film subjected to immersion in water at 60° C. for one hour with a peel test carried out immediately after withdrawal from the water bath.

The addition of the nanoparticle, ZnO, to the composition substantially improves the peel strength of a bond after immersion in water at 60° C. The improvement in the peel strength and moisture resistance is unexpected in view of the prior art.

We claim:

1: An energy-curable composition comprising a dual-functional energy polymerizable component, a nanoparticle metal oxide, and, optionally, a polymerization initiator.

2: The composition of claim 1 comprising from about 1% to about 99% by weight of the dual-functional energy polymerizable component.

3: The composition of claim 2 comprising from 10% to 90% by weight of dual-functional energy polymerizable component.

4: The composition of claim 3 comprising from 25% to 75% by weight of the dual functional energy polymerizable component.

5: The composition of claim 1 comprising from about 0.01 to about 20% by weight of nanoparticle metal oxide.

6: The composition of claim 5 comprising from 0.1 to 15% by weight of the nanoparticle metal oxide.

7: The composition of claim 2 comprising the dual-functional energy polymerizable component, nanoparticle zinc oxide and a functional component copolymerizable with the dual-functional energy polymerizable component in an amount of from about 5% to about 75% by weight of the energy-curable composition.

8: The composition of claim 7 wherein the copolymerizable component is present in an amount of 10% to 60% by weight of the energy curable composition.

9: The composition of claim 8 wherein the copolymerizable component is present in an amount of from 15% to 50% by weight of the energy-curable composition.

10: The composition of claim 1 wherein the nanoparticle metal oxide comprises at least one metal oxide selected from the group consisting of zinc oxide, titanium dioxide and aluminum oxide.

11: The energy-curable composition of claim 1 comprising up to about 30% by weight of additives.

12: The energy-curable composition of claim 1 comprising from about 10% to about 75% by weight of the dual function energy polymerizable component, from about 5% to about 75% by weight of a functional component copolymerizable with dual-functional energy polymerizable component, 0.01% to 20% by weight of the nanoparticle metal oxide, up to 30% by weight of additives and a polymerization initiator.

13: The energy-curable composition of claim 12 wherein the nanoparticle metal oxide comprises zinc oxide.

14: An electron beam cured composition of claim 1.

15: An electron beam cured composition of claim 7.

16: An electron beam cured composition of claim 12.
